(19) United States
(12) Patent Application Publication
(10) Pub. No.: US 2025/0390287 A1
(43) Pub. Date: Dec. 25, 2025

(54) Framework for Language Agent Based Function Calling

(71) Applicant: Booz Allen Hamilton Inc., McLean, VA (US)

(72) Inventors: Michael Anthony DeLeo, Cranberry TWP, PA (US); Joshua LUXTON, Vienna, VA (US)

(73) Assignee: Booz Allen Hamilton Inc., McLean, VA (US)

(21) Appl. No.: 19/249,266

(22) Filed: Jun. 25, 2025

Related U.S. Application Data
(60) Provisional application No. 63/663,862, filed on Jun. 25, 2024.

(51) Int. Cl. G06F 8/35; G06F 8/36

(52) U.S. Cl. CPC G06F 8/35; G06F 8/36

(57) ABSTRACT

Embodiments relate to a system for generating a language output. The system can include a function call system including a processor with an interfacing module configured to interface the processor with a database and a natural language processing (NLP) model. The processor can generate a function call by: importing a base function class for identifying function calling programming code within the NLP model; defining a function for the function call; defining an output format for a response of the function call. The system can include an interfacing system configured to: generate a user interface configured to receive a human generated input; generate a prompt including the function call; and transmit the function call to the NLP model to generate a response that is a recognition of text, a generation text, and/or prediction of text based on a human generated input.

### CROSS-REFERENCE TO RELATED APPLICATIONS

This patent application is related to and claims the benefit of priority of U.S. provisional patent application No. 63/663,862, filed on Jun. 25, 2024, the entire contents of which is incorporated herein by reference.

### FIELD

Embodiments relate to a system for generating a language output by using a function call operator to import a base function class for identifying function calling programming code within the NLP model, which can be used to define a function for the function call and an output format for a response of the function call.

### BACKGROUND INFORMATION

known function calling frameworks are either too complex, execute dangerous remote code, or are just inefficient to use. Known techniques can be appreciated from:
1. CN 118114771 (Liu et al.).
2. CN 117786064 (Yang et al.).
3. CN 117112065 (Xie et al.).
4. Chen, W., & Li, Z. (2024). Octopus V2: On-device Language Model for Super Agent. arXiv preprint arXiv: 2404.01744.
5. Prompt Engineering Guide (2024). Function Calling with LLMs. Retrieved from https://www.promptingguide.ai/applications/function_calling.
6. Greyling, C. (2023). Langchain Agents With Openai Function Calling. Retrieved from https://cobusgreyling.medium.com/langchain-agents-with-openai-function-calling-54a6e5573ec9.
7. Lorica, B. (2024). Function Calling AI: Transforming Text Models into Dynamic Agents. Retrieved from https://www.linkedin.com/pulse/function-calling-ai-transforming-text-models-dynamic-ben-lorica-%E7%BD%97%E7%91%9E%E5%8D%A1-p3iuf

### SUMMARY

An exemplary embodiment can relate to a function call system for generating a function call as a computer operated instruction initiated by a human generated input. The system can include a processor including an interfacing module configured to interface the processor with a database and a natural language processing (NLP) model. The system can include a memory having instructions stored thereon that when executed by the processor can cause the processor to generate a function call one or more of the functions disclosed herein. Instructions can cause the processor to: import a base function class for identifying function calling programming code within the NLP model; define a function for the function call; defining an output format for a response of the function call; generate a prompt including the function call; and transmit the function call to the NLP model to generate a response that is a recognition of text, a generation text, and/or prediction of text based on a human generated input.

An exemplary embodiment can relate to a method for generating a function call as a computer operated instruction initiated by a human generated input. The method can include interfacing a processor with a database and a natural language processing (NLP) model. The method can include generating a function call by one or more functions disclosed herein. The method can include importing a base function class for identifying function calling programming code within the NLP model; defining a function for the function call; defining an output format for a response of the function call; generating a prompt including the function call; and transmitting the function call to the NLP model to generate a response that is a recognition of text, a generation text, and/or prediction of text based on a human generated input.

An exemplary embodiment can relate to a computer readable medium including instructions stored thereon that when executed by a processor can cause the processor to generate a function call as a computer operated instruction initiated by a human generated input by executing one or more functions disclosed herein. The instructions can include interfacing a processor with a database and a natural language processing (NLP) model; and generating a function call by: importing a base function class for identifying function calling programming code within the NLP model; defining a function for the function call; defining an output format for a response of the function call; generating a prompt including the function call; and transmitting the function call to the NLP model to generate a response that is a recognition of text, a generation text, and/or prediction of text based on a human generated input.

An exemplary embodiment can relate to a system for generating a language output from a human generated language input. The system can include a function call system. The function call system can include a processor having an interfacing module configured to interface the processor with a database and a natural language processing (NLP) model; a memory having instructions stored thereon that when executed by the processor can cause the processor to generate a function call by executing one or more of the functions disclosed herein. The instructions can include: importing a base function class for identifying function calling programming code within the NLP model; defining a function for the function call; defining an output format for a response of the function call. The system can include an interfacing system including a memory having instructions stored thereon that when executed by the processor can cause the processor to perform any of the functions disclosed herein. The instructions can include: generating a user interface configured to receive a human generated input; generating a prompt including the function call; and transmitting the function call to the NLP model to generate a response that is a recognition of text, a generation text, and/or prediction of text based on a human generated input.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary function call system for generating a function call;

FIGS. 2A and 2B show an exemplary function call registration flow diagram;

FIG. 3 shows an exemplary operational flow diagram for an embodiment of the system; and

FIG. 4 show an exemplary recursive call function flow diagram;

### DETAILED DESCRIPTION

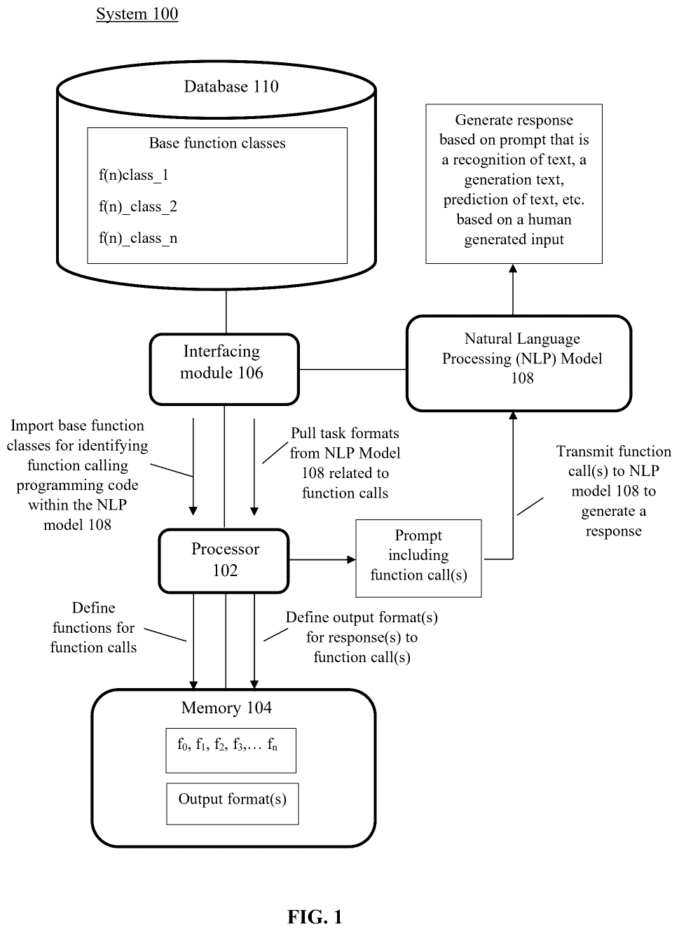

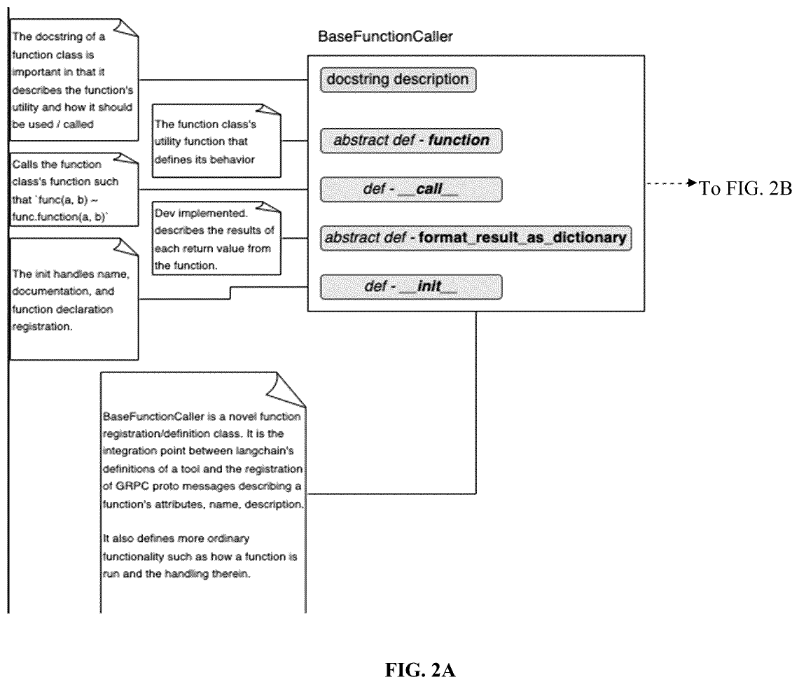

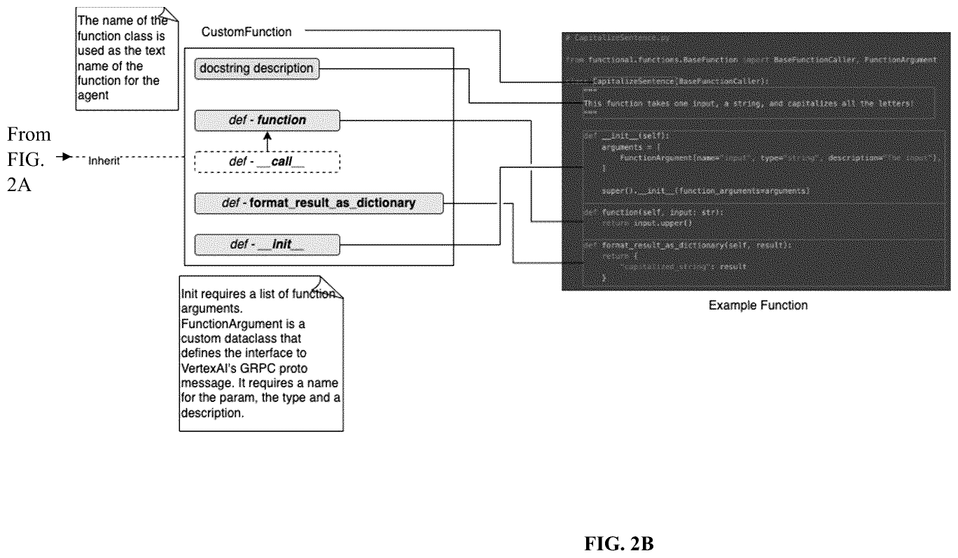

Referring to FIGS. 1, 2A, and 2B, embodiments disclosed herein improve operation of one or more processors 102. This can be achieved by implementing a model that will improve efficiency of processor operation by generating a function call system 100 that facilitates incorporation of simplified descriptive functions and execution of functions recursively so that function responses can be used as part of a call/invocation of other functionalities. This allows an agent (e.g., a chat agent) using the function call system to quickly identify function calls to obtain responses from a Natural Language Processing (NLP) model.

Embodiments of the function call system 100 and/or any of its components can include one or more processors 102 and one or more memories 104. The processor(s) 102 can be configured to execute instructions to facilitate signal processing, data manipulation, data storage, execution of algorithms, and so forth. For instance, any of the processors 102 can be in operative association with memory 104 which includes instructions (e.g., logic, algorithms, models, etc.) stored thereon that when executed by the processor 102 will cause the processor 102 to carry out one or more of the functions disclosed herein. It is contemplated for the processors to receive electrical, optical, and/or electro-optical signals, process those signals, perform computations with the processed signals, and transmits information and/or commands to other components. Thus, the processors 102 can be equipped with lead lines, waveguides, electrical/optical connectors/couplers, switches/circuitry, processing blocks, analog-to-digital converters (ADC), digital-to-analog converters (DAC), filters, processing blocks, transceivers, antennas, and so forth to facilitate receiving/transmitting, processing, and storing signals and data.

Any of the processors 102 can include or be operatively associated with a memory 104. The memory 104 can store instructions thereon which can be executed by the processor 102 to perform any of the functions disclosed herein. The instructions can be in the form of computer logic, algorithms, models, etc. and stored as a computer program, a data structure, and so forth. While exemplary embodiments are described and/or illustrated with one processor 102 and one memory 104, it is understood that any of the systems 100 and/or a component of the system 100 can include any number of processors 102 and memories 104 within the single processor 102 or memory 104.

The processor 102 can be part of or in communication with a machine (logic, one or more components, circuits (e.g., modules), or mechanisms). The processor 102 can be hardware (e.g., processor, integrated circuit, central processing unit, microprocessor, core processor, computer device, etc.), firmware, software, or any combination thereof configured to perform operations by execution of instructions embodied in algorithms, data processing program logic, artificial intelligence programming, automated reasoning programming, and so forth. Use of processors 102 herein can include any one or combination of a Graphics Processing Unit (GPU), a Field Programmable Gate Array (FPGA), a Central Processing Unit (CPU), and so forth. The processor 102 can include one or more operating modules or sub-processors. An operating module or sub-processor can be a software or firmware operating module or sub-processor configured to implement any of the method steps disclosed herein. The operating module or sub-processor can be embodied as software and stored in memory 104, the memory 104 being operatively associated with the processor 102. An operating module or sub-processor can be embodied as a web application, a desktop application, a console application, and so forth.

The processor 102 can include or be associated with a computer or machine-readable medium. The computer or machine-readable medium can include memory. The computer or machine-readable medium can be configured to store one or more instructions thereon. The instructions can be in the form of algorithms, program logic, a model, or any combination therefor that cause the processor 102 to perform any of the functions described herein.

Any of the memory 104 discussed herein can be computer readable memory configured to store data. The memory 104 can include a volatile or non-volatile, transitory or non-transitory memory, and be embodied as an in-memory, an active memory, a cloud memory, or any combination thereof. Embodiments of the memory 104 can include an operating module or sub-processor and other circuitry to allow for the transfer of data to and from the memory 104, which can include to and from other components of a communication system. This transfer can be via hardwire or wireless transmission. The communication system can include transceivers, which can be used in combination with switches, receivers, transmitters, routers, gateways, waveguides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, or any combination thereof.

The processor 102 can be in communication with other processors of other devices (e.g., a computer device, a desktop computer, a laptop computer, a computer system, and so forth). Any of those other devices can include any of the exemplary processors 102 disclosed herein. Any of the processors 102 can have transceivers or other communication devices/circuitry to facilitate transmission and reception of wireless signals. Any of the processors 102 can include an Application Programming Interface (API) as a software intermediary that allows two applications to talk to each other. Use of an API can allow software of the processor 102 of the system 100 to communicate with software of the processor of the other device(s), if the processor 102 of the system 100 is not the same processor of the device.

Any data transmission between a processor 102 and a memory 104, between a processor 102 and a database, between a processor 102 and processors 102 of other devices, between a processor 102 of one operating module or sub-processor and a processor 102 of another operating module or sub-processor, and so forth can be via a pull operation (e.g., the processor 102 can pull the data) or a push operation (e.g., the data can be pushed to the processor 102). The processor 102 can receive and process the data in steaming format, store it in memory before being processed, and so forth.

The processor 102 can be configured to be a component of, used in combination with, or in communication with another device/system—e.g., this can include the processor being part of the device/system, the device/system being part of the processor, the processor in communication with the device/system, etc. “Being part of” can include being on a same substrate or integrated circuit.

A processor 102 can be a component of, used in combination with, or in communication with a predictive modeling system, a decision support system, an automated control system, and so forth. A processor 102 can use the techniques disclosed herein to assist with or augment the performance of these devices/systems.

Embodiments can relate to a function call system 100 for generating one or more function calls. The function call(s) can be generated as a computer operated instruction(s) initiated by a human generated input(s). For instance, the function call system 100 can be part of or in communication with an application (e.g., a chat agent) that receives a request and generates a response to the request. In this regard, the function call system 100 can serve as a function call operator for a chat agent—e.g., the function call system 100 can be a function call operator that is part of or executed by a chat agent. The chat agent can be configured to provide answers to questions, generate a summary or analytic report of evidence-based data, generate an assessment or recommendation report of intelligence-based data, and so forth. An exemplary implementation can be a user asking a chat agent whether document X pertains to or discusses subject Y. A user can supply the system XX with document X and information related to subject Y. The chat agent can then use the function call operator to generate a response to facilitate determining whether document X pertains to or discusses subject Y, determine that document X pertains to or discusses subject Y, determine a relevancy document X has to do with subject Y, and so forth.

The function call system 100 can include one or more processors 102. The function call system 100 can include one or more interfacing modules 106 or interfacing sub-processors configured to interface the processor 102 with one or more databases 110 and one or more natural language processing (NLP) models 108. The NPL model 108 can be stored in memory of the system 100 or in memory of another system (e.g., computer system or computer device). The NPL model 108 can be accessed and executed by the processor 102 of the system 100 or by a processor of another system. The memory that stores the NLP model 108 can have one or more trained neural networks that make up a neural network architecture (e.g., weight, biases, and so forth) for the NLP model 108, which can be stored as one or more containers in the memory.

The function call system 100 can include one or more memories 104. The memory 104 can have instructions stored thereon that when executed by the processor 102 can cause the processor 102 to generate a function call(s). For instance, instructions can cause the processor 102 to import one or more base function classes for identifying function calling programming code within the NLP model 108. A base function class can be a fundamental class that defines a set of common attributes and methods. In some embodiments, the fundamental class that defines a set of common attribute and methods can be used as a blueprint for other classes. For instance, a derived function classes can be a function class that inherits properties and methods from a base function class. An exemplary technique for calling a base function class to import it can involve use of a scope resolution operator in C++, for example. A user of the system 100 can call the base function class(es) manually via invoking scope resolution operator(s), for example. In addition, or in the alternative, the processor 102 can use a machine learning algorithm(s) to call the base function class(es) automatically. The base function classes can be stored in one or more databases 110. Thus, after calling the base function class(es) for a given NLP model 108, the processor 102 can store them in the database 110 for subsequent retrieval. There can be any number of base function classes (e.g., f(n)class_1, f(n)class_2, . . . f(n)class_n) for identifying function calling programming code within the NLP model 108.

Instructions can cause the processor 102 to define one or more functions for one or more function calls. A function call is a statement that executes a function. For instance, sticking with the chat agent example in which a user asks whether document X pertains to document Y, the function call be a statement that causes the system 100 to execute one or more functions to achieve this determination. It is contemplated for the function(s) to be executed in conjunction with the NLP model(s) 108, and thus the function call(s) can be a statement(s) that involves passing control of NLP model(s) 108 to the function(s). In this regard, the system 100 can define a function for the function call by incorporating a descriptive docstring into the function call.

The function call begins with an invocation. The invocation can be the function call initiating execution of a specific function by the statement requiring the NLP model 108 to run program code related to the function. The statement can include one or more arguments (e.g., a function argument). Argument(s) can be value(s) that is/are passed to parameter(s) related to operation(s) of a function(s)—e.g., the values can invoke operation parameters that define a function. Thus, when defining a function for the function call, the processor 102 can specify one or more parameters related to operations of a function. The function call, which has statements including arguments (e.g., values passed to the parameters), can allow the NLP model 108 to execute operations of the function. When an NLP model 108 receives the function call(s), its general execution flow can be interrupted by the statement(s) so as to allow or cause the function's code to be executed in accordance with the function(s) as defined by the argument(s). Thus, a processor operating the NLP model 108 can transfer control (e.g., execution of the NPL model 108), or transfer at least a portion of control, to the called function(s). An exemplary technique for defining a function can involve use of a statement result operator in which values x, y, and z (for example) are used as a function call for a function so as to define a specific function—e.g., values x, y, and z are used (or passed) as arguments for defining the specific function. The function(s) can be defined by a user (e.g., as an input to the system 100), automatically via the processor 102 (e.g., a machine learning algorithm can be used to define the function(s), and so forth.

Instructions can cause the processor 102 to define one or more output formats for one or more responses of the function call(s). An output format of the NLP model 108 can depend on specific task(s) the NLP model 108 is designed to perform. Exemplary NLP model 108 tasks and corresponding output formats can include: a) sentiment analysis (output can be a classification, a probability based on a class(es), and so forth; b) machine translation (output can be text translated into the target language); c) named entity recognition (output can be identified entities, labels characterizing the entities, and so forth; d) topic modeling (output can be a list of topics defined by a set of words, assignment(s) of topics, and so forth); e) text generation (output can be newly generated text based on a genres or formats; f) information retrieval (output can be a list of documents or texts that are most relevant to a query; g) summarization (output can be a shorter version of input text based on relevancy to a query; h) embeddings (output can be a vector(s) in an embedding space(s) representing input text; and so forth. The output format can therefore depend on how the NLP model 108 will be used. The output format can be defined by a user (e.g., as an input to the system 100), automatically via the processor 102 (e.g., a machine learning algorithm can be used to determine which output format to use, and so forth.

Instructions can cause the processor 102 to generate one or more prompts including the function call(s). The prompt can be text given to the NLP model 108 to guide its output by acting as an instruction and/or context for the NLP model 108. In this regard, the prompt can be designed to steer the NLP model 108 toward a specific output format. The prompt can be defined by a user (e.g., as an input to the system 100), automatically via the processor 102 (e.g., a machine learning algorithm can be used to generate the prompt, and so forth.

Instructions can cause the processor 102 to transmit the function call(s) to the NLP model(s) 108. This can be via transmitting the prompt(s) that include(s) the function call(s) to the NLP model(s) 108. The function call can cause the NLP model 108 (or a processor executing the NLP model 108) to generate one or more responses. It is contemplated for the response(s) to be a recognition of text, a generation text, prediction of text based, and so forth. The response(s) can be based on a human generated input—e.g., a user asking a chat agent whether document X pertains to or discusses subject Y. The function call system 100 can use a response(s) of a function call(s) as an invocations for a functionality(ies) of the function call(s) or an invocation(s) for another function call(s).

As can be appreciated, importing base function classes for identifying function calling programming code within the NLP model 108 improves efficiency of processor 102 operation because the function call system 100 can incorporate simplified descriptive functions for execution of functions recursively or in one shot. Furthermore, function responses can be used as part of a call/invocation of other functionalities. This also allows an agent (e.g., a chat agent) using the function call system to quickly identify function calls to obtain responses from a NLP model 108.

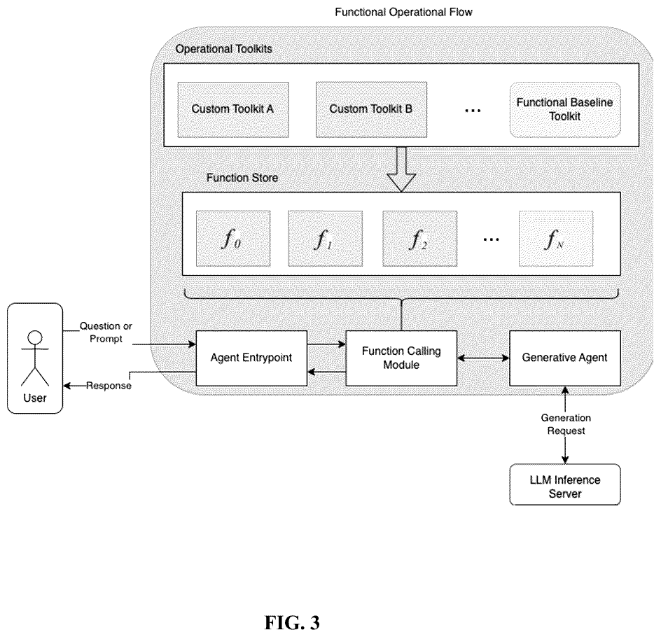

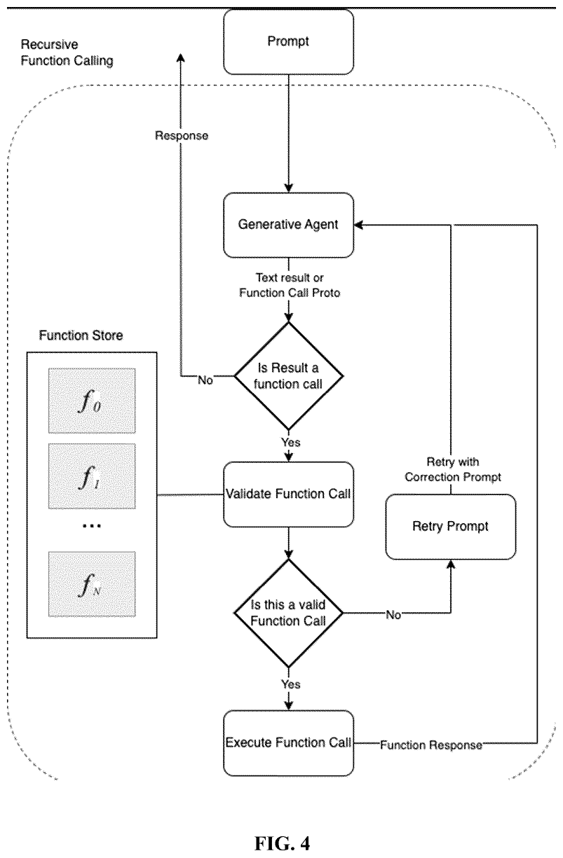

Referring to FIGS. 3-4, tin addition, or in the alternative, any of the function calls as defined by using the techniques disclosed herein can be stored in memory 104. This can allow the function call system 100 to generate and store function calls in memory 104 which can be pulled from when receiving a request and operating with a NLP model 108. It is contemplated for the system 100 to generate and store plural function calls, and thus instructions can cause the processor 102 to generate plural function calls. This can include generating function calls in successive order, in parallel, or combination of both. The function calls can be for a single request (e.g., a single request by a user to the chat agent), multiple requests (e.g. multiple requests by a user to the chat agent), and so forth. Any number of the function calls can be for a specific NLP model 108, and any number of other function calls can be for a different NLP model 108, and so forth. Any number of the function calls can be stored in memory 104. When pulling from the memory 104, it is contemplated for the function call system 100 to perform a recursive function via a generative model to select one or more function calls from the plural function calls.

An exemplary embodiment can relate to a method for generating a function call as a computer operated instruction initiated by a human generated input. The method can include interfacing a processor 102 with a database 110 and a natural language processing (NLP) model 108. The method can include generating a function call by importing a base function class for identifying function calling programming code within the NLP model 108. The method can include defining a function for the function call (e.g., incorporating a descriptive docstring into the function call). The method can include defining an output format for a response of the function call. The method can include generating a prompt including the function call. The method can include transmitting the function call to the NLP model 108 to generate a response that is a recognition of text, a generation text, a prediction of text and so forth based on a human generated input.

The method can include generating plural function calls. The method can include storing the plural function calls. The method can include performing a recursive function via a generative model to select a function call from the plural function calls. The method can include using a response of a function call as an invocation for a functionality of the function call or an invocation for another function call.

The method can include generating a response via a chat agent. The method can include providing answers to questions, generate a summary or analytic report of evidence-based data, generate an assessment or recommendation report of intelligence-based data and so forth via the chat agent.

An exemplary embodiment can relate to a computer readable medium 104 including instructions stored thereon that when executed by a processor 102 can cause the processor 102 to generate a function call as a computer operated instruction initiated by a human generated input by. The function call can be generated by interfacing a processor with a database and a natural language processing (NLP) model 108, and then generating a function call. This can be achieved by instructions causing the processor 102 to import a base function class for identifying function calling programming code within the NLP model 108, define a function for the function call, define an output format for a response of the function call, generate a prompt including the function call, and transmit the function call to the NLP model 108 to generate a response. The response can be a recognition of text, a generation text, prediction of text and so forth based on a human generated input.

An exemplary embodiment can relate to a system for generating a language output from a human generated language input. The system can include a function call system 100. The function call system 100 can include a processor 102 including an interfacing module 106 or sub-processor configured to interface the processor 102 with a database 110 and a natural language processing (NLP) model 108. The function call system 100 can include a memory 104 having instructions stored thereon that when executed by the processor 102 can cause the processor 102 to generate a function call by: importing a base function class for identifying function calling programming code within the NLP model 108; defining a function for the function call; and defining an output format for a response of the function call. The system can include an interfacing system (e.g., interfacing module 106 or sub-processor). The interfacing system can include a processor 102 and a memory 104 having instructions stored thereon that when executed by the processor can cause the processor 102 to: generate a user interface configured to receive a human generated input; generate a prompt including the function call; and transmit the function call to the NLP model 108 to generate a response that is a recognition of text, a generation text, prediction of text and so forth based on a human generated input.

### Examples

The following discusses exemplary implementations of the techniques disclosed herein.

Embodiments of the system/method/apparatus discussed in the Examples section may be referred to herein as “Functional”. Functional relates to a function call system for generating a function call as a computer operated instruction initiated by a human generated input. The system can include a processor having an interfacing module configured to interface the processor with a database and a natural language processing (NLP) model. The processor can be configured to generate one or more function calls by importing a base function class for identifying function calling programming code within the NLP. The processor can then define a function for the function call, define an output format for a response of the function call, and generate a prompt including the function call. The function call can then be transmitted to the NLP model to generate a response.

In an exemplary implementation, Functional is configured as a python framework and platform for language agent based function calling. The technology's platform provides a sandbox environment for communicating with the framework's default agent and an API for serving the default or other variations of the default agent. The framework can also be integrated into existing projects for the development of custom functions, toolkits, and agents. Functional combines the tool framework of langchain with the generative content generation tools of Google's vertex AI to provide an easy function creation framework that handles the boilerplate code of working with GRPC proto messages, langchain overhead, function descriptions, and coaxing the model to properly handle and call functions recursively or in one shot.

There has been a resurgence in interest towards large language models (LLM), with the advent of Gemini 1.0, 1.5 as well as GPT, and ChatGPT companies have been trying to apply these models towards complex business problems. One of the deficiencies in large language models is their inherent lack of real knowledge. Retrieval Augmented Generation (RAG) systems are that which information is stored in a vector database and an LLM is used to query and retrieve documents with appropriate context. Another, but less popular system that is used to cover the knowledge deficit is “function calling”.

Function calling is the process of giving a large language model context on a function(s)'s parameters, output and utility and expecting the model to either (1) execute the function itself and provide an output or (2) provide a set of parameters to run the function. It is a tricky practice to accurately and repeatedly encourage an LLM to consistently make function calls, and some solutions will choose either path for their solution. Typically having an LLM perform the function's logic yields inconsistent and expensive (cost, time, computation) results. Functional is performing the second form of function calling. One other note on function calling is that the name is somewhat of a misnomer, the model itself is not actually calling a function, but rather the ai system is interpreting the mode's output to call the function.

Functional is a python framework and platform for language agent based function calling. The technology's platform provides a sandbox environment for communicating with the framework's default agent and an API for serving the default or other variations of the default agent. The framework can also be integrated into existing projects for the development of custom functions, toolkits and agents. Functional combines the tool framework of langchain with the generative content generation tools of Google's vertex AI to provide an easy function creation framework that handles the boilerplate code of working with GRPC proto messages, langchain overhead, function descriptions, and coaxing the model to properly handle and call functions recursively or in one shot.

An inventive aspect for the Functional framework is how it extends current technologies to make it easier for developers to reliably build functions for complex business use cases. The system is also reliable at higher numbers of functions, and can even enable an LLM to perform recursive function calls where the agent can call any combination and number of functions to answer the user's inquiry.

Several mature, competitive solutions exist for function calling.

Marvin AI. Marvin AI is a python framework that defines pydantic interface classes and coaxes open ai's GPT model to fill out the data models based on prior info. Marvin also has “AI Functions” where the model is instructed to implement a function based on parameter inputs and a description.

Google Vertex AI Function Calling. With Google Vertex AI, one can use function calling to define custom functions and provide these to a generative AI model. While processing a query, the model can choose to delegate certain data processing tasks to these functions. It does not call the functions. Instead, it provides structured data output that includes the name of a selected function and the arguments that the model proposes the function to be called with. Vertex AI's function calling uses GRPC proto messages to define the function call interfaces, function responses and general responses from the model.

Langchain. Langchain is an open source python framework for developing applications powered by large language models (LLMs). Langchain has a structured way for creating “tools” which is their term for functions.

OpenAI. OpenAI is a non-profit startup seeking to develop AI before anyone else. They developed function calling as a feature of their ChatGPT system where users can develop and create functions that the model will constrict itself to and create a JSON the user can call the function with BabyAGI. BabyAGI is an open source platform that is seeking to create the first AGI system. The system uses a task queuing system with multiple agents assuming roles in the system in combination with a vector database to effectively answer questions. In some ways the project uses function calls as tasks.

Open Interpreter (O1). O1 is a Startup that created a device that functions similarly to Siri and allows a person to perform tasks with the agent. They released an open source version of their framework that involves function calling.

These function call techniques leave it to the agent to create code to run a function which is dangerous and ineffective. Functional's capabilities can be similar to existing solutions but one aspect in which it is differentiated is in how it allows functions to be defined and used. Functional inherits and uses Langchain's framework for defining functions while simultaneously building off of Google's function calling framework while adding its own flavor of simplified and descriptive functions. The baseline agent in Functional can execute functions recursively and use functions responses as part of the call/invocation of other functionalities enabling an architecture that allows the agent and user to quickly work through utilities to get a question answered. In addition, the ease of adding and creating custom functions is a differentiating point.

As noted herein, current function calling frameworks are either too complex, execute dangerous remote code, or are just inefficient to use. Additionally, current function calling frameworks fail to provide means to leverage shat interface agents. Functional, however, helps developers to quickly implement custom functions that model complex business logic without worrying about how a language model might execute the logic. Functional is a robust function calling framework that handles the scaling, organization and agent herding involved with creating an effective chat bot with useful utilities. Additionally, functional provides a sandbox environment where clients can test out the functionality and envision their own use cases which empowers new revenue generation. Additional benefits of Functional can include:
1. Increased developer productivity: Developers can focus on creating the logic of their functions without worrying about the complexities of integrating them with the chat agent. This can lead to faster development times and lower costs.
2. Improved code reusability: Functions can be easily reused across different chat agents, which can save time and effort for developers. This can also help to ensure consistency in the way that functions are used.
3. Enhanced modularity: Functions can be broken down into smaller, more manageable units, which makes them easier to test and debug. This can also make it easier to scale the chat agent as needed.
4. Greater flexibility: Developers can easily add new functions to the chat agent without having to modify the underlying codebase. This allows them to quickly respond to changes in user needs and requirements.
5. Improved maintainability: Functions are easier to maintain and update than code that is tightly coupled to the chat agent. This can help to ensure that the chat agent remains up-to-date and bugfree.

As can be appreciated, Functional enables teams to easily build and maintain modular toolsets that pertain to specific client missions, products or functions and rapidly deploy them in a chat agent setting. The flexible and simple nature of functional allows it to be useful in many contexts.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the systems and methods using and making the same disclosed herein have been discussed and illustrated, it is to be distinctly understood that the invention is not limited thereto but may be otherwise variously embodied and practiced within the scope of the following claims.

What is claimed is:

1. A function call system for generating a function call as a computer operated instruction initiated by a human generated input, comprising:
a processor including an interfacing module configured to interface the processor with a database and a natural language processing (NLP) model;
a memory having instructions stored thereon that when executed by the processor will cause the processor to generate a function call by:
importing a base function class for identifying function calling programming code within the NLP model;
defining a function for the function call;
defining an output format for a response of the function call;
generating a prompt including the function call; and
transmitting the function call to the NLP model to generate a response that is a recognition of text, a generation text, and/or prediction of text based on a human generated input.

2. The function call system of claim 1, wherein instructions will cause the processor to:
generate plural function calls.

3. The function call system of claim 2, wherein instructions will cause the processor to:
store the plural function calls in the memory.

4. The function call system of claim 3, wherein instructions will cause the processor to:
perform a recursive function via a generative model to select a function call from the plural function calls.

5. The function call system of claim 4, wherein instructions will cause the processor to:
use a response of a function call as an invocation for a functionality of the function call or an invocation for another function call.

6. The function call system of claim 1, wherein instructions will cause the processor to:
define a function for the function call by incorporating a descriptive docstring into the function call.

7. The function call system of claim 1, wherein instructions will cause the processor to:
define a function for the function call by defining a function argument including one or more parameters and on or more values.

8. The function call system of claim 1, wherein:
the function call system is a function call operator that is part of or executed by a chat agent.

9. The function call system of claim 8, wherein:
the chat agent is configured to provide answers to questions, generate a summary or analytic report of evidence-based data, and/or generate an assessment or recommendation report of intelligence-based data.

10. A method for generating a function call as a computer operated instruction initiated by a human generated input, the method comprising:
interfacing a processor with a database and a natural language processing (NLP) model; and
generating a function call by:
importing a base function class for identifying function calling programming code within the NLP model;
defining a function for the function call;
defining an output format for a response of the function call;
generating a prompt including the function call; and
transmitting the function call to the NLP model to generate a response that is a recognition of text, a generation text, and/or prediction of text based on a human generated input.

11. The method of claim 10, comprising:
generating plural function calls.

12. The method of claim 11, comprising:
storing the plural function calls.

13. The method of claim 12, comprising:
performing a recursive function via a generative model to select a function call from the plural function calls.

14. The method of claim 13, comprising:
using a response of a function call as an invocation for a functionality of the function call or an invocation for another function call.

15. The method of claim 10, comprising:
defining a function for the function call by incorporating a descriptive docstring into the function call.

16. The method of claim 10, comprising:
defining a function for the function call by defining a function argument including one or more parameters and on or more values.

17. The method of claim 10, comprising:
generating a response via a chat agent.

18. The method of claim 17, comprising:
providing answers to questions, generate a summary or analytic report of evidence-based data, and/or generate an assessment or recommendation report of intelligence-based data via the chat agent.

19. A computer readable medium including instructions stored thereon that when executed by a processor will cause the processor to generate a function call as a computer operated instruction initiated by a human generated input by:
interfacing a processor with a database and a natural language processing (NLP) model; and
generating a function call by:
importing a base function class for identifying function calling programming code within the NLP model;
defining a function for the function call;
defining an output format for a response of the function call;
generating a prompt including the function call; and
transmitting the function call to the NLP model to generate a response that is a recognition of text, a generation text, and/or prediction of text based on a human generated input.

20. A system for generating a language output from a human generated language input, comprising:
a function call system, comprising:
a processor including an interfacing module configured to interface the processor with a database and a natural language processing (NLP) model;
a memory having instructions stored thereon that when executed by the processor will cause the processor to generate a function call by:
importing a base function class for identifying function calling programming code within the NLP model;
defining a function for the function call;
defining an output format for a response of the function call; and
an interfacing system comprising:
a processor and a memory having instructions stored thereon that when executed by the processor will cause the processor to:
generate a user interface configured to receive a human generated input;
generate a prompt including the function call; and
transmit the function call to the NLP model to generate a response that is a recognition of text, a generation text, and/or prediction of text based on a human generated input.
